(19) United States
(12) Patent Application Publication
(10) Pub. No.: US 2025/0362385 A1
(43) Pub. Date: Nov. 27, 2025

(54) ECHO SIGNAL RECEIVING METHOD AND DEVICE, TERMINAL DEVICE, AND STORAGE MEDIUM

(71) Applicant: SUTENG INNOVATION TECHNOLOGY CO., LTD., Shenzhen (CN)

(72) Inventor: Changsheng GONG, Shenzhen (CN)

(73) Assignee: SUTENG INNOVATION TECHNOLOGY CO., LTD., Shenzhen (CN)

(21) Appl. No.: 19/214,011

(22) Filed: May 20, 2025

(30) Foreign Application Priority Data
May 24, 2024 (CN) 202410657809.5

(51) Int. Cl. G01S 7/48; G01S 7/4861; G01S 7/487

(52) U.S. Cl. CPC G01S 7/4802; G01S 7/4861; G01S 7/487

(57) ABSTRACT

The application provides an echo signal receiving method and device, a terminal device and a storage medium, and is applied to a LiDAR system. The LiDAR system includes a photosensitive receiving array, and the photosensitive receiving array includes a plurality of photosensitive subunits. The echo signal receiving method includes the following steps: collecting a level state signal of each photosensitive subunit; performing phase shift on the level state signal according to a phase shift time corresponding to each photosensitive subunit, where phase shift times corresponding to at least two photosensitive subunits are not equal; and fusing the phase-shifted level state signal to obtain a target echo signal.

### CROSS-REFERENCE TO RELATED APPLICATION

The present application claims the benefit of priority to Chinese Patent Application No. 202410657809.5, filed on May 24, 2024, which is hereby incorporated by reference in its entirety.

### TECHNICAL FIELD

The present application relates to the technical field of LiDAR, and in particular to an echo signal receiving method and device, a terminal device and a storage medium.

### TECHNICAL BACKGROUND

A LIDAR is used to measure not only near objects but also far objects. When measuring, the target object can be a high-reflectivity object or a low-reflectivity object. When detecting a near object or a high-reflectivity object, echo saturation often leads to poor measurement precision. When detecting a far object or a low-reflectivity object, the measurement precision is also poor due to weak echo intensity. Therefore, when the LiDAR deals with target objects of different distances and different reflectivities, the dynamic range of the obtained echo signal in the time domain is crucial to the measurement precision of the LiDAR. The dynamic range of the echo signal in the time domain can be characterized by its pulse width, rising edge duration, and falling edge duration.

Therefore, there is an urgent need to provide a signal receiving method capable of expanding the dynamic range of the echo signal in the time domain, thereby improving the measurement precision of the LiDAR.

### SUMMARY

Embodiments of the present application provide an echo signal receiving method and device, terminal equipment, and a storage medium, which can effectively expand the dynamic range of the echo signal in the time domain and improve the measurement precision of the LiDAR.

In a first aspect, embodiments of the present application provide an echo signal receiving method applied to a LiDAR system, where the LiDAR system includes a photosensitive receiving array, the photosensitive receiving array includes a plurality of photosensitive subunits. The method includes the following steps: acquiring a level state signal of each photosensitive subunit; performing phase shift on the level state signal according to a phase shift time corresponding to each photosensitive subunit, where the phase shift times corresponding to at least two photosensitive subunits are different; and fusing the phase-shifted level state signal to obtain a target echo signal.

In an implementation form of the first aspect, the performing phase shift on the level state signal according to a phase shift time corresponding to each photosensitive subunit includes:
determining a delay time of a sampling moment of the photosensitive subunit according to the phase shift time; and after the delay time, triggering the photosensitive subunit to output the level state signal.

In an implementation form of the first aspect, the performing phase shift on the level state signal according to a phase shift time corresponding to each photosensitive subunit includes: inputting the level state signal into a data shifter corresponding to the phase shift time to perform sampling moment shift.

In an implementation form of the first aspect, after the acquiring a level state signal of each photosensitive subunit, the method further includes: interpolating the level state signal output by the photosensitive subunit.

In an implementation form of the first aspect, the photosensitive receiving array includes at least two photosensitive subunits with different photon detection efficiencies.

In a second aspect, an echo signal receiving apparatus includes: a photosensitive receiving array including a plurality of photosensitive subunits; an acquisition unit, connected with the photosensitive receiving array, configured to acquire a level state signal output by the photosensitive receiving array; a phase shifting unit, connected with the acquisition unit, configured to shift the phase of the level state signal according to a phase shifting time of each photosensitive subunit, where the phase shifting times corresponding to at least two photosensitive subunits are different; and a fusion unit, connected with the phase shifting unit, configured to fuse the level state signal after phase shifting to obtain a target echo signal.

In an implementation form of the second aspect, the phase shifting unit includes a clock generator and a delay unit. The clock generator is configured to generate a sampling moment, and the delay unit is configured to delay an acquisition moment of the acquisition unit.

In an implementation form of the second aspect, the delay unit includes a serial delay unit and/or a parallel delay unit.

In an implementation form of the second aspect, the phase shifting unit includes a data shifter, and the data shifter is configured to shift the level state signal at the sampling moment.

In an implementation form of the second aspect, the echo signal receiving apparatus further includes an interpolation unit configured to interpolate the level state signal output by the photosensitive subunit.

In an implementation form of the second aspect, the echo signal receiving apparatus further includes a power supply unit including at least two power supply units with different power supply voltages and/or power supply currents, and the power supply units are configured to supply power to corresponding photosensitive subunits.

In a third aspect, an embodiment of the present application provides a terminal device. The terminal device includes a processor, a memory, and a computer program stored in the memory and executable on the processor, where the processor executes the computer program to implement the method in the first aspect or any implementation of the first aspect.

In a fourth aspect, an embodiment of the present application provides a computer-readable storage medium. The computer-readable storage medium stores a computer program, where the computer program is executed by a processor to implement the method in the first aspect or any implementation of the first aspect.

In a fifth aspect, an embodiment of the present application provides a computer program product. When the computer program product is executed on a terminal device, the computer program product causes the terminal device to execute the method in the first aspect or any implementation of the first aspect.

Compared with the prior art, embodiments of the present application have the following beneficial effects:

The echo signal receiving method and apparatus, the terminal device, and the computer-readable storage medium provided by embodiments of the present application shift the phase of the level state signal output by the photosensitive subunit, and at least two phase shifting times are different, thereby improving the dynamic range of the sampling number. The target echo signal obtained by fusing the level state signal after phase shifting has a larger dynamic range in the time domain, and the measurement precision of the LiDAR can be improved.

### BRIEF DESCRIPTION OF DRAWINGS

In order to more clearly illustrate the embodiments of the present application or the technical solutions in the prior art, the drawings are briefly introduced below. Obviously, the drawings described below are only some embodiments of the present application. For ordinary technicians in this field, other drawings can be obtained based on these drawings without any creative work.

FIG. 1 is a schematic diagram of a structure of a LiDAR system according to an embodiment of the present application;

FIG. 2 is a schematic diagram of a photosensitive receiving array according to an embodiment of the present application;

FIG. 3 is a schematic diagram of an echo signal receiving device according to an embodiment of the present application;

FIG. 4 is a schematic diagram of an echo signal receiving device according to an embodiment of the present application;

FIG. 5 is a schematic diagram of another phase shift manner of setting a delay unit on a sampling clock according to an embodiment of the present application;

FIG. 6 is a schematic diagram of another phase shift manner of setting a delay unit on a sampling clock according to an embodiment of the present application;

FIG. 7 is a schematic diagram of a shift manner of a data shifter according to an embodiment of the present application;

FIG. 8 is a schematic diagram of a fusion process of sampling data without phase shift according to an embodiment of the present application;

FIG. 9 is a schematic diagram of a fusion process of sampling data without phase shift according to an embodiment of the present application;

FIG. 10 is a schematic diagram of an echo signal after fusion of sampling data without phase shift and a target echo signal after fusion of sampling data after phase shift according to an embodiment of the present application;

FIG. 11 is a schematic diagram of another echo data receiving device according to an embodiment of the present application;

FIG. 12 is a schematic diagram of a process of interpolating a level state signal output by a photosensitive subunit according to an embodiment of the present application;

FIG. 13 is a schematic diagram of another echo signal receiving device according to an embodiment of the present application;

FIG. 14 is a schematic diagram of a power supply unit according to an embodiment of the present application;

FIG. 15 is an echo diagram of a receiving module with constant PDE receiving an echo signal reflected by a high-reflectivity object or an echo signal reflected by a close object according to an embodiment of the present application;

FIG. 16 is an echo diagram of an echo signal receiving device receiving an echo signal reflected by a high-reflectivity object or an echo signal reflected by a close object according to an embodiment of the present application;

FIG. 17 is a schematic diagram of an implementation process of an echo signal receiving method according to an embodiment of the present application;

FIG. 18 is a schematic diagram of an implementation process of another echo signal receiving method according to an embodiment of the present application;

FIG. 19 is a schematic diagram of a terminal device according to an embodiment of the present application; and

FIG. 20 is a schematic diagram of a chip according to an embodiment of the present application.

### DETAILED DESCRIPTION

In the following description, for purposes of explanation and not limitation, specific details are set forth, such as particular architectures, technologies, techniques, etc. in order to provide a thorough understanding of the present application. However, it will be apparent to those skilled in the art that the present application can be practiced in other embodiments that depart from these specific details. In other instances, detailed descriptions of well-known systems, devices, circuits, and methods are omitted so as not to obscure the description of the present application with unnecessary detail.

It should be understood that the term “and/or” used in the present description and the appended claims specifies any combination of one or more of the associated listed items and all possible combinations. In addition, in the description of the present application and the appended claims, the terms “first,” “second,” “third,” etc. are only used to distinguish the description, and cannot be understood as indicating or implying relative importance.

It should also be understood that, in the description of the present application, reference to “one embodiment” or “some embodiments” etc. means that a particular feature, structure, or characteristic described in connection with the embodiment is included in at least one embodiment of the present application. Thus, the appearances of the phrases “in one embodiment,” “in some embodiments,” “in other embodiments,” “in additional embodiments” etc. in various places throughout the specification are not necessarily all referring to the same embodiment, unless otherwise specifically noted. The terms “comprising,” “comprises,” “including,” “includes,” and “having,” and their conjugates mean “including but not limited to,” unless otherwise expressly specified.

LiDAR is a radar system for detecting the position and speed of a target by emitting a laser beam. In addition to detecting the distance of an object, the LiDAR can also detect the reflectivity of the object for target recognition. The specific working principle of LiDAR is to emit a detection signal to a target. After the detection signal reaches the target, it is reflected by the target object to form echo data. The LiDAR receives the signal (echo data) reflected by the target, and then determines the information about the target, such as distance, position, height, speed, attitude, shape, reflectivity, etc. of the target based on the echo data, thereby achieving target detection, tracking, and recognition.

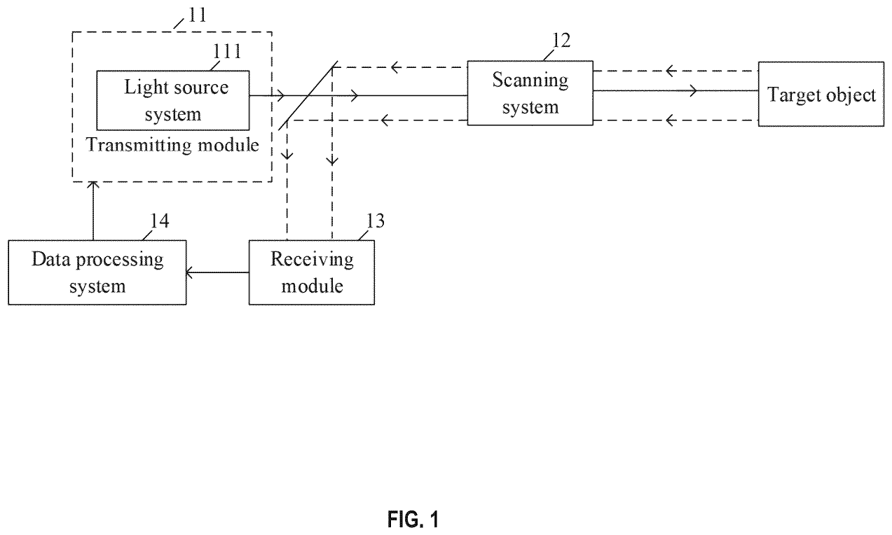

As shown in FIG. 1, the LiDAR 10 generally includes a transmitting module 11, a scanning system 12, a receiving module 13, and a data processing system 14. The transmitting module 11 can include a light source system 111.

The light source system 111 is used to generate a laser beam required by the LiDAR 10. The light source system 111 can include a laser and optical components such as a transmitting lens group. The scanning system 12 is used to deflect the laser beam generated by the light source system 111 at an angle, so that the laser beam can hit different positions at different moments. The scanning system 12 can be a mechanical scanning system (e.g., a rotating driving platform) or a semi-solid scanning system (e.g., a rotating mirror, a vibrating mirror, or a combination of the two). The present application does not limit the form of the scanning system. It can be understood that the LiDAR in the present application can also be a solid-state LiDAR, that is, scanning is achieved by controlling light sources at different angles to emit light in sequence.

The laser beam emitted by the light source system is reflected by the target object after reaching the target object, and the reflected light pulse is received by a photosensitive receiving array in the receiving module 13, and the echo signal is processed based on the output signal of the photosensitive receiving array to generate corresponding detection information.

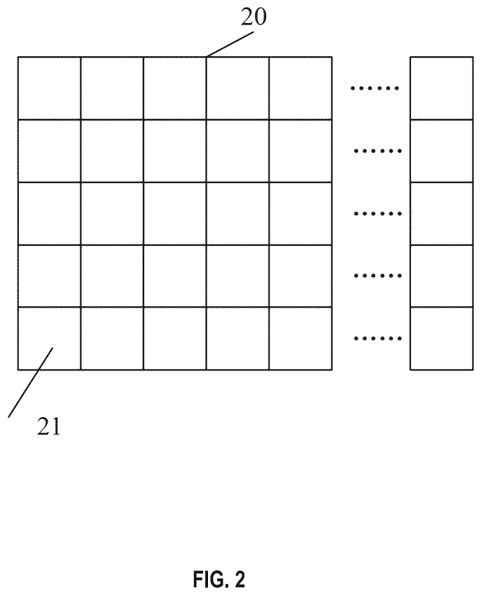

As shown in FIG. 2, the photosensitive receiving array 20 includes a plurality of photosensitive subunits 21. After the echo beam hits the photosensitive receiving array 20, the covered photosensitive subunits 21 can output corresponding electrical signals. The electrical signals output by the photosensitive subunits 21 can be collected by an acquisition unit, and a plurality of signals collected by the acquisition unit are synthesized to obtain echo data corresponding to the echo beam.

It should be noted that the photosensitive receiving array 20 can be rectangular as shown in FIG. 2, or circular, or of other shapes.

It should be noted that the photosensitive receiving array 20 can be a Single Photon Avalanche Diode (SPAD) array or a Silicon photomultiplier (SiPM) array, and the present application does not limit the specific form.

The LiDAR needs to measure not only near-distance objects but also far-distance objects. When measuring, the target object can be a high-reflectivity object or a low-reflectivity object. When the LiDAR detects the near-distance object or the high-reflectivity object, the measurement precision of the LiDAR is often poor due to echo saturation. When the LiDAR detects the far-distance object or the low-reflectivity object, the measurement precision is also poor due to weak echo intensity. Therefore, when the LiDAR deals with target objects of different distances and different reflectivities, the dynamic range of the obtained echo signal in the time domain is crucial to the measurement precision of the LiDAR. The dynamic range of the echo signal in the time domain can be characterized by pulse width, rising edge duration, and falling edge duration.

Based on this, embodiments of the present application provide an echo signal receiving method, which phase shifts the level state signal output by the photosensitive subunit, and at least two unequal phase shift times exist, so that the dynamic range of the sampling number is improved, the target echo signal obtained by fusing the phase-shifted level state signal can have a larger dynamic range in the time domain, and the measurement precision of the LiDAR can be improved.

The echo signal receiving method and the echo signal receiving device provided by embodiments of the present application are described in detail below.

Before introducing the echo signal receiving method provided by embodiments of the present application, an echo signal receiving device provided by an embodiment of the present application is described.

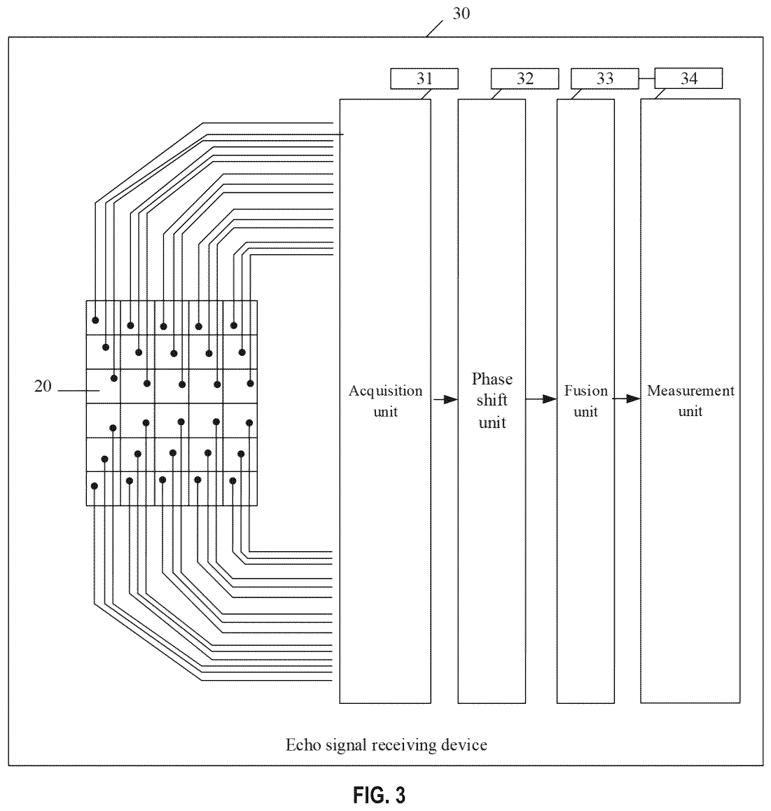

Referring to FIG. 3, which shows a structural schematic diagram of an echo signal receiving device provided by embodiments of the present application. As shown in FIG. 3, the echo signal receiving device 30 can include a photosensitive receiving array 20, an acquisition unit 31, a phase shift unit 32, a fusion unit 33, and a measurement unit 34. The acquisition unit 31 is connected with the photosensitive receiving array 20 and the phase shift unit 32 respectively, the fusion unit 33 is connected with the phase shift unit 32, and the measurement unit 34 is connected with the fusion unit 33.

The photosensitive receiving array 20 is used to receive an echo light beam.

In some embodiments, the photosensitive receiving array 20 includes a plurality of photosensitive subunits 21. After the echo light beam hits the photosensitive receiving array 20, the covered photosensitive subunits 21 can output corresponding electrical signals, thereby forming the level state signal output by the photosensitive receiving array 20.

The acquisition unit 31 is used to acquire the level state signal output by the photosensitive receiving array 20.

In some embodiments, the acquisition of the electrical signal output by each photosensitive subunit 21 by the acquisition unit 31 is synchronous acquisition. That is, the output electrical signal of the photosensitive subunit 21 is acquired at the same time, or when the phase shift unit 32 sets a delay unit on a sampling clock to achieve time delay to realize phase shift, the acquisition time of the electrical signal output by each photosensitive subunit 21 can be all different or partially different.

The phase shifting unit 32 is configured to shift the phase of the level state signal according to the phase shifting time corresponding to each photosensitive subunits21.

In some embodiments, the phase shifting unit 32 partially or totally shifts the phase of the result output by an acquisition unit 31. The phase shifting manner can be time delay of the collected level state signal by using a data shifter, or time delay by setting a delay unit on a sampling clock, so as to realize phase shifting.

In an implementation, the echo signal receiving apparatus can be a receiving chip.

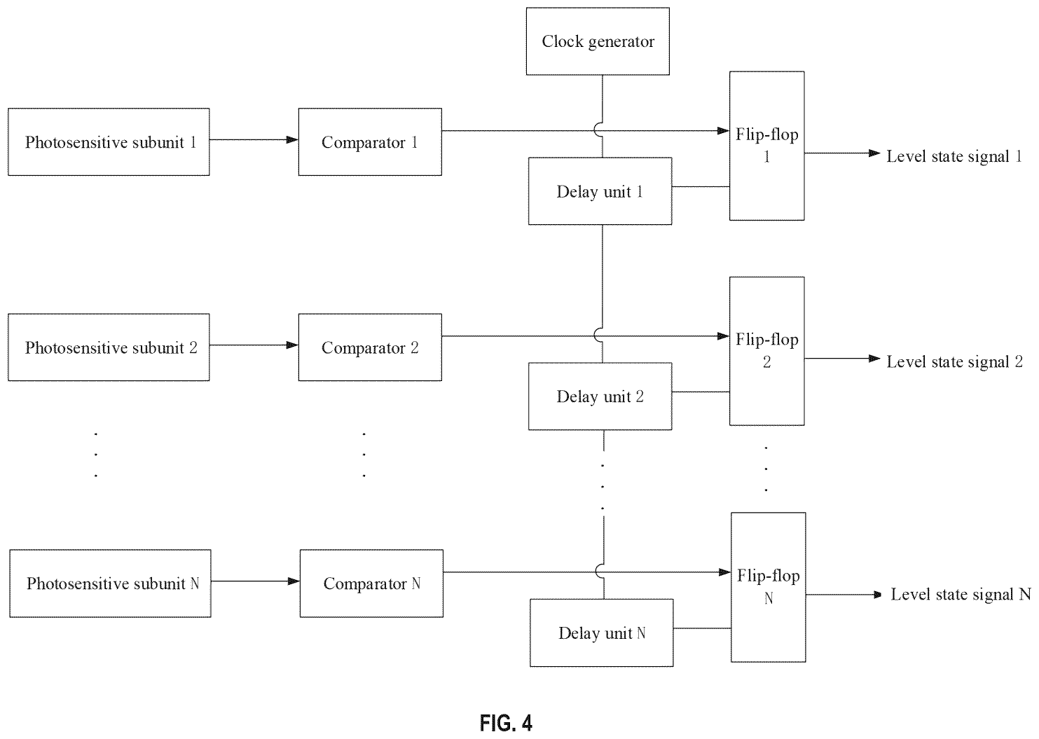

In an implementation, referring to FIG. 4, which shows an architecture schematic diagram of a phase shifting manner of setting a delay unit on a sampling clock. As shown in FIG. 4, a serial delay unit structure can be used to realize clock delay on the sampling clock. For the electrical signal output by the photosensitive subunit 1, the level state signal output by the trigger 1 after the comparator 1 is compared can be obtained after the delay time t₁ corresponding to the delay unit 1. For the electrical signal output by the photosensitive subunit 2, the level state signal 2 output by the trigger 2 after the comparator 2 is compared can be obtained after the delay time t₁ corresponding to the delay unit 1 and the delay time t₂ corresponding to the delay unit 2 are accumulated (i.e. t₁+t₂). Similarly, for the electrical signal output by the photosensitive subunit N, the level state signal N output by the trigger N after the comparator N is compared can be obtained after the delay time t₁ corresponding to the delay unit 1, the delay time t₂ corresponding to the delay unit 2, . . . , and the delay time t_{N} corresponding to the delay unit N are accumulated (i.e. t₁₊₂+ . . . +t_{N}).

It should be noted that the clock unit generator in FIG. 4 is used to generate a sampling moment. After the sampling moment passes through the delay unit, the flip-flop triggers the echo signal sampling of the photosensitive subunit, that is, the level state signal of the corresponding photosensitive subunit is collected.

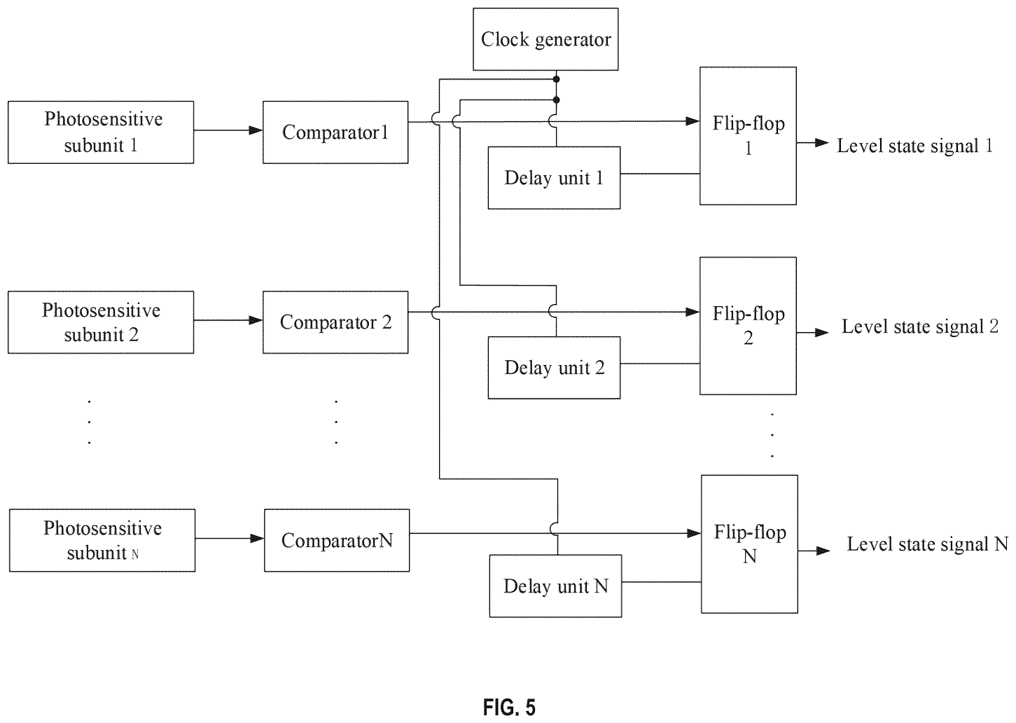

In another implementation, referring to FIG. 5, which shows a schematic diagram of another phase shift manner of setting the delay unit on the sampling clock. As shown in FIG. 5, the clock delay on the sampling clock can also be implemented by using a parallel delay unit structure. For the electrical signal output by the photosensitive subunit 1, the electrical signal passes through the delay time t₁ corresponding to the delay unit 1, and then the level state signal 1 is obtained by the comparator 1 after being output by the flip-flop 1; for the electrical signal output by the photosensitive subunit 2, the electrical signal passes through the delay time t₂ corresponding to the delay unit 2, and then the level state signal 2 is obtained by the comparator 2 after being output by the flip-flop 2; for the electrical signal output by the photosensitive subunit N, the electrical signal passes through the delay time t_{N} corresponding to the delay unit N, and then the level state signal N is obtained by the comparator N after being output by the flip-flop N.

It should be understood that at least two delay times in t₁, t₂, . . . , t_{N} are different, and in some embodiments, each delay time in t₁, t₂, . . . , t_{N} is different.

It should be noted that the phase shift manner of setting the delay unit on the sampling clock can also be implemented by using a combination of series and parallel configurations. The phase shift may not be applied to some photosensitive subunits, and the phase shift times of some photosensitive subunits may be the same.

It should be noted that in another implementation of the present application, some or all of the photosensitive subunits 1, 2, . . . , n can correspond to one or more delay units. When a photosensitive unit corresponds to multiple delay units, the sampling number of the echo signal of the photosensitive unit can be increased, so that the measurement accuracy of the LiDAR can be further improved. It should be understood that the phase shift manner of the multiple delay units can be implemented by using a combination of series and/or parallel configurations.

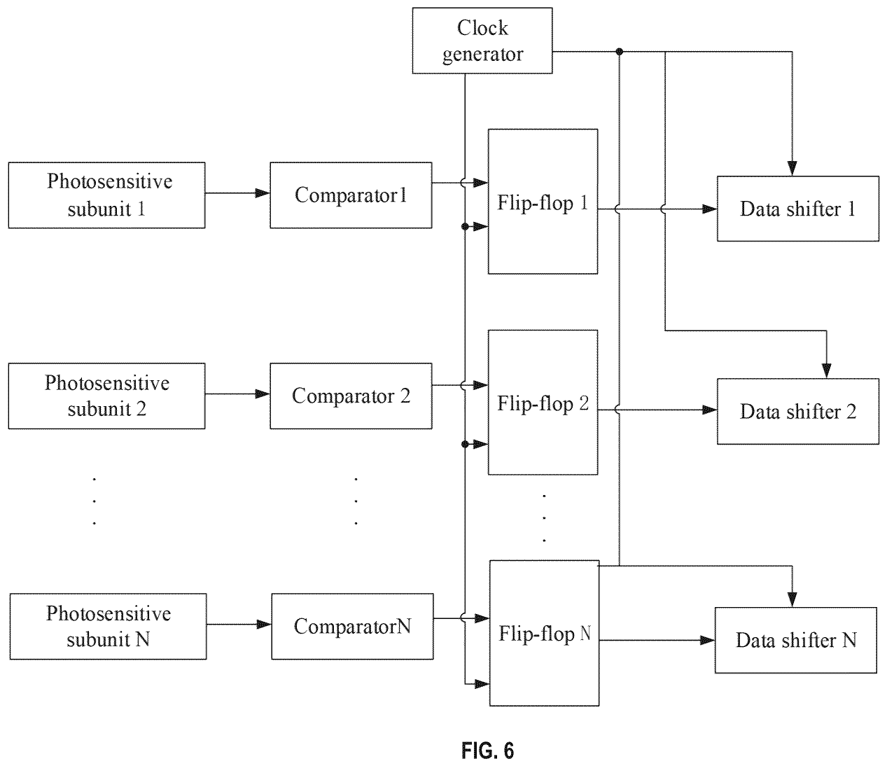

In another implementation of the present application, the phase shift unit 32 can also shift the phase of the level state signal output by the acquisition unit 31 at the same sampling moment by using a data shifter corresponding to each photosensitive subunit 21. For example, referring to FIG. 6, which shows a schematic diagram of the architecture of the phase shift method by using the data shifter. As shown in FIG. 6, the photosensitive subunit 1 triggers the flip-flop 1 to output the corresponding level state signal at the sampling moment generated by the clock generator, and then the level state signal is shifted in sampling moment by the data shifter 1 according to the phase shift time corresponding to the photosensitive subunit 1. The photosensitive subunit 2 triggers the flip-flop 2 to output the corresponding level state signal at the sampling moment generated by the clock generator, and then the level state signal is shifted in sampling moment by the data shifter 2 according to the phase shift time corresponding to the photosensitive subunit 2. In this way, the photosensitive subunit N triggers the flip-flop N to output the corresponding level state signal at the sampling moment generated by the clock generator, and then the level state signal is shifted in sampling moment by the data shifter N according to the phase shift time corresponding to the photosensitive subunit N, thereby shifting the phase of the level state signal.

It should be noted that for a photosensitive subunit that does not require phase shifting, the data shifter may not be connected to that photosensitive subunit, or the phase shift time of the data shifter connected to the photosensitive subunit may be set to 0.

It should be further noted that the data shifter is a device capable of adjusting the sampling moment corresponding to the current sampling data (i.e., the level state signal).

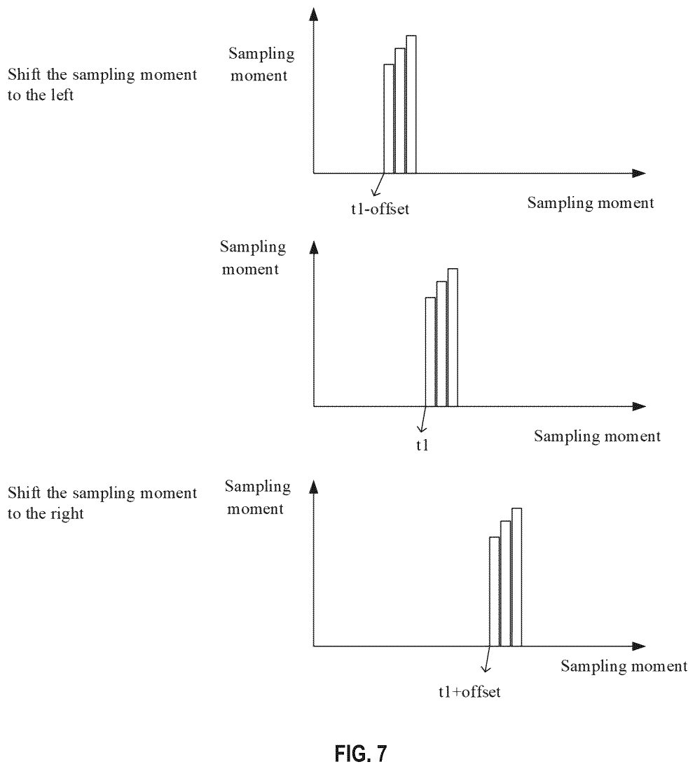

For example, as shown in FIG. 7, the sampling moment of the level state of the photosensitive subunit 1 is t₁. The data shifter can shift the sampling moment to the left or right, i.e., advance or delay. For example, adjusting the sampling moment to t₁-offset is left shifting data, i.e., advancing the sampling moment by offset; while adjusting the sampling moment to t₁+offset is right shifting data, i.e., delaying the sampling moment by offset.

The fusion unit 33 can fuse the phase-shifted level state signals to obtain the target echo signal.

In some embodiments, when performing data fusion, the fusion unit 33 can superimpose the level state signals output by the photosensitive subunits 21 at the same moment to obtain the fused target echo signal.

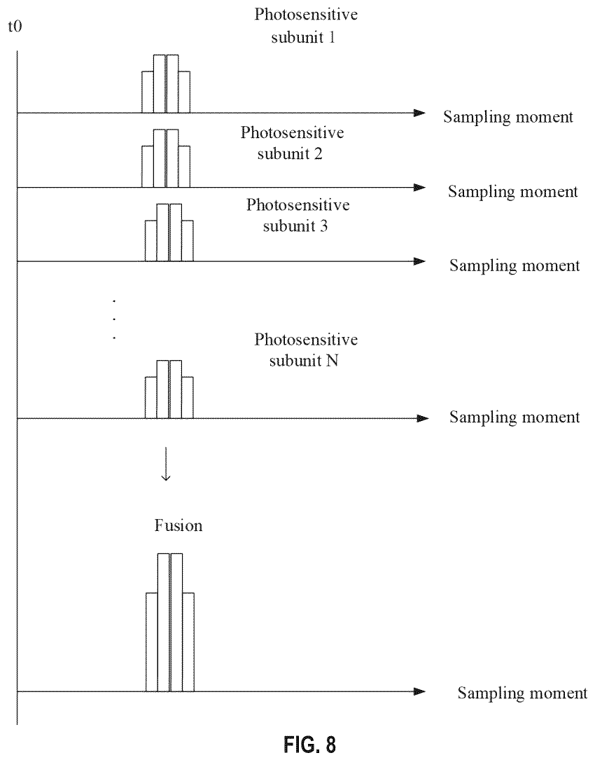

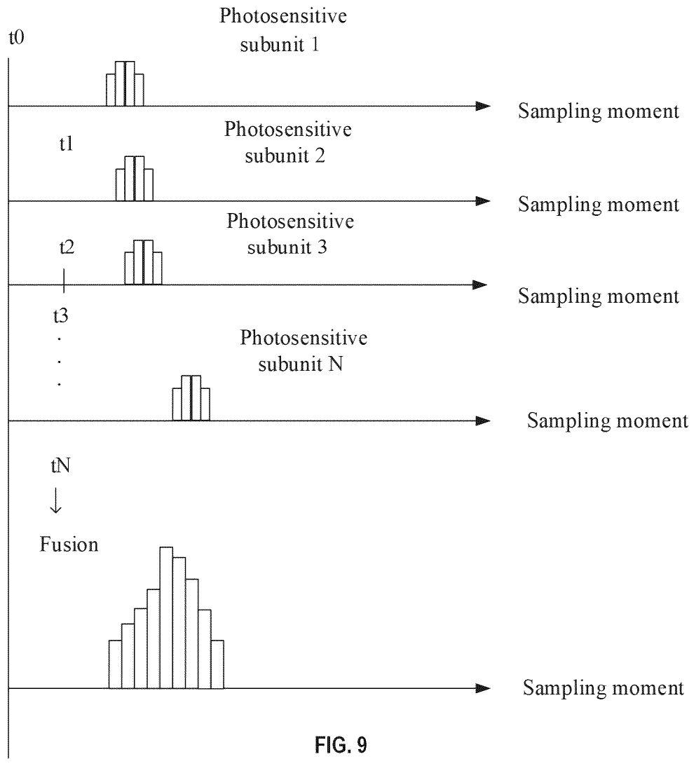

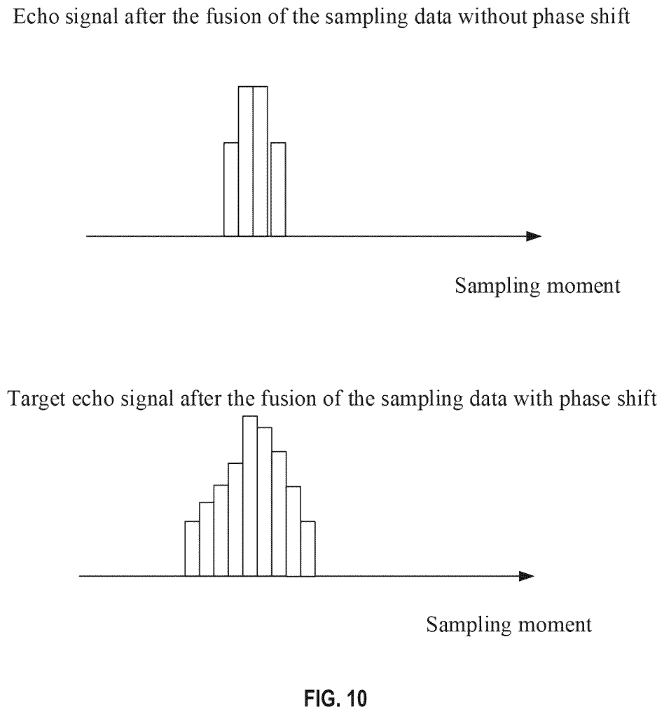

Referring to FIG. 8 to FIG. 10, FIG. 8 is a schematic diagram of the fusion process of the sampling data without phase shift, FIG. 9 is a schematic diagram of the fusion process of the sampling data with phase shift, and FIG. 10 is a comparison diagram of the echo signal after the fusion of the sampling data without phase shift and the target echo signal after the fusion of the sampling data with phase shift. As shown in FIG. 8, after fusing the level state signals that have been phase-shifted by the phase shift unit, the pulse width sampling data, the rising edge sampling data, and the falling edge sampling data of the target echo signal are significantly increased. Therefore, the target echo signal obtained after fusion can have a larger dynamic range, thereby effectively improving the measurement accuracy of the LiDAR system.

The measurement unit 34 can perform target identification and distance calculation according to the target echo signal.

It should be noted that the process of target identification and distance calculation based on the target echo signal may refer to existing identification and calculation methods, and will not be repeated in the present application.

It should be further noted that the above is only an exemplary description of the structure of the echo signal receiving device provided in embodiments of the present application, and the echo signal receiving device can further include other modules/units, such as a storage unit, for storing echo data, etc.

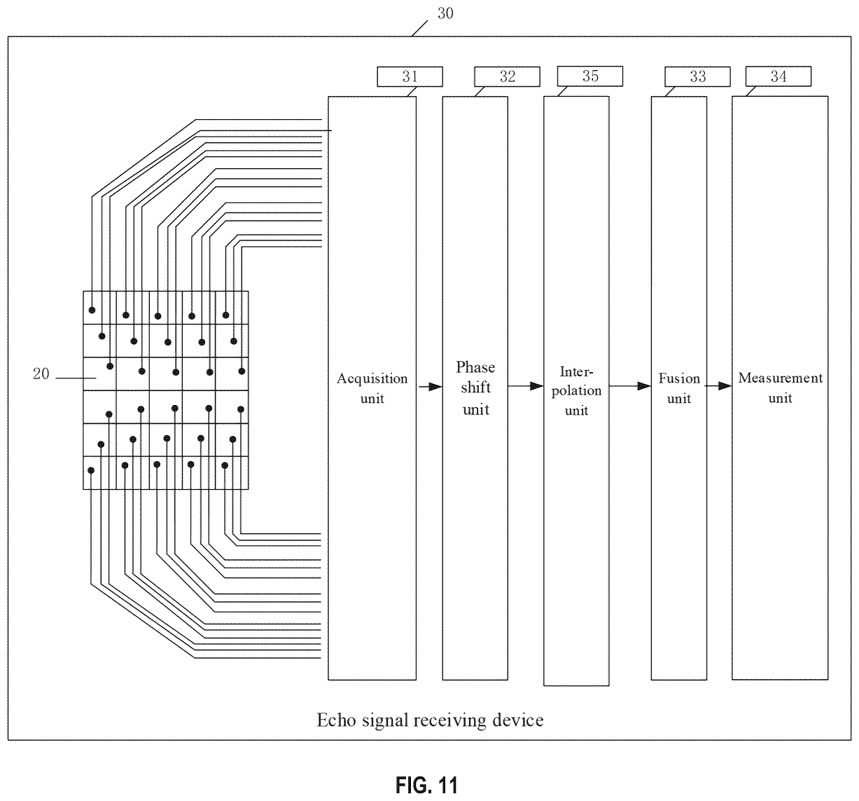

In order to further increase the dynamic range of the echo signal in the time domain, as shown in FIG. 11, the echo signal receiving device 30 can further include an interpolation unit 35.

The interpolation unit 35 is used for interpolating the level state signals output by the photosensitive subunits.

In some embodiments, the interpolation unit 35 can set the interpolation multiple according to sampling accuracy requirement, and may use a linear interpolation method, a spline interpolation method, or a polynomial interpolation method. The present application does not impose any specific limitation in this regard.

It should be noted that the interpolation methods used by different photosensitive subunits can be the same or different, and the present application does not impose any specific limitation in this regard.

It should be understood that, for the phase shift manner involving sampling time adjustment as shown in FIG. 4 and FIG. 5, the level state signals after phase shifting can be interpolated. For the phase shift manner using a data shifter as shown in FIG. 6, the level state signals can be interpolated either before the phase shift or after the phase shift.

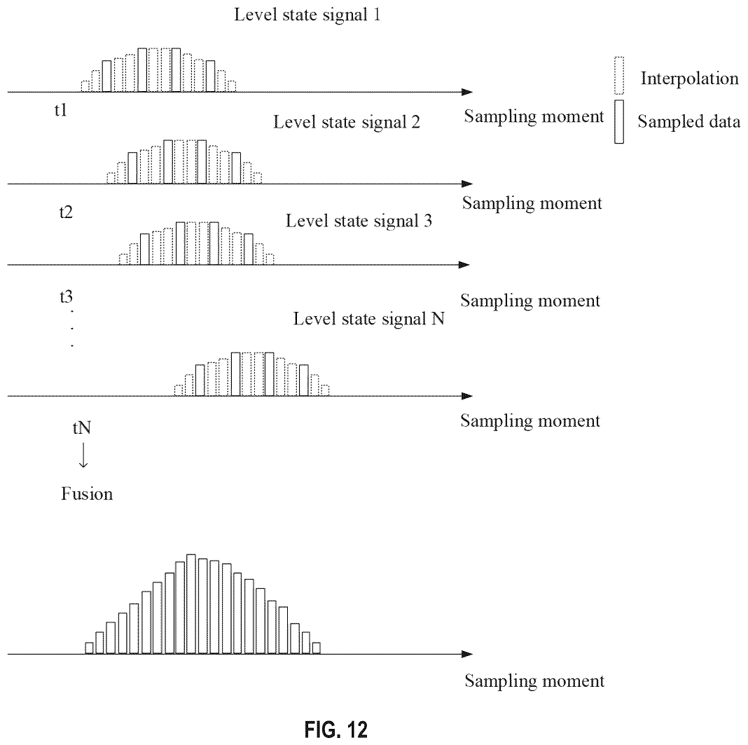

For example, referring to FIG. 12, which is a schematic diagram of a process in which the interpolation unit interpolates the level state signals output by the photosensitive subunits. As shown in FIG. 12, the interpolation unit 35 can interpolate each of the level state signals output by the photosensitive subunits. That is, for the level state signal output by the photosensitive subunit 1, after the phase shift time t₁, interpolation is performed to obtain the phase-shifted and interpolated level state signal 1; for the level state signal output by the photosensitive subunit 2, after the phase shift time t₂, interpolation is performed to obtain the phase-shifted and interpolated level state signal 2; and so on, for the level state signal output by the photosensitive subunit N, after the phase shift time t_{N}, interpolation is performed to obtain the phase-shifted and interpolated level state signal N.

The fusion unit 33 is configured to fuse the phase-shifted and interpolated level state signals to obtain the target echo signal.

It should be noted that the LiDAR system can interpolate the level state signals output by only a portion of the photosensitive subunits, depending on the precision requirement. The target echo signal obtained by fusing the phase-shifted and interpolated level state signals has more pulse width samples, rising edge samples, and falling edge samples, which can further improve the dynamic range of the echo signal in the time domain, and further improve the measurement precision of the LiDAR system.

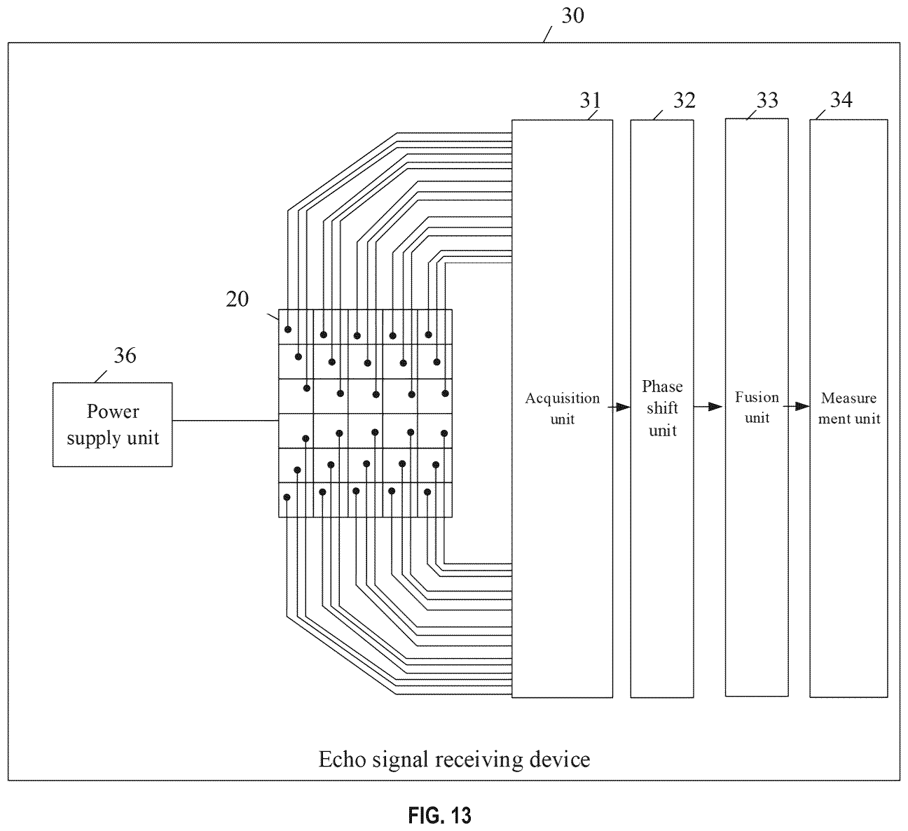

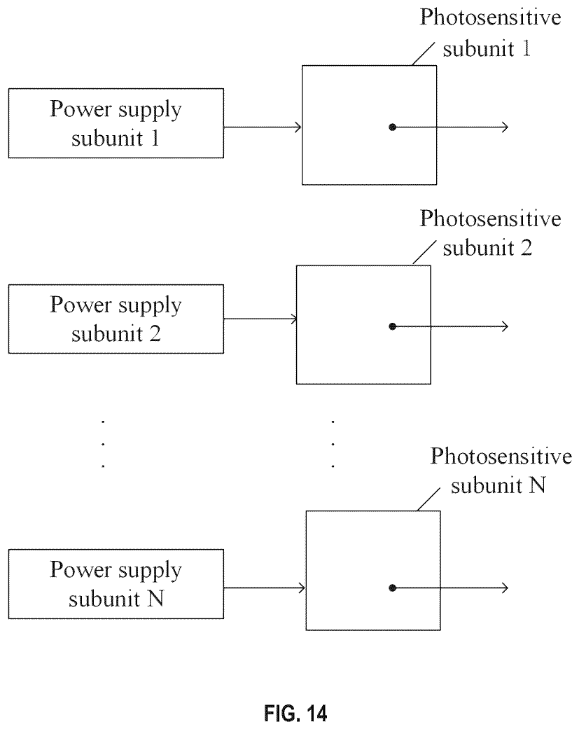

Referring to FIG. 13, which is a schematic diagram of a structure of an echo signal receiving device according to another embodiment of the present application. As shown in FIG. 13, the photosensitive receiving array can be powered by a power supply unit 36. As shown in FIG. 14, the power supply unit 36 can include a plurality of power supply subunits, each of which can correspond to one or more photosensitive subunits, and the power supply subunit corresponding to a photosensitive subunit provides working power for the photosensitive subunit, and at least two power supply subunits output different power supply voltages and/or different power supply currents.

The power supply voltages and/or the power supply currents output by the power supply subunits are different, so that the photosensitive subunits have different photon detection efficiencies (PDEs).

It can be understood that the photosensitive subunit working at a high PDE can detect objects at a farther distance, and the photosensitive subunit working at a low PDE can reduce echo saturation of objects at a short distance or with a high reflectivity. After the high-PDE photosensitive subunit and the low-PDE photosensitive subunit are independently sampled by the sampling unit, the sampled data (i.e., the level state signals) are either phase-shifted or phase-shifted and interpolated, and the level state signals of all the photosensitive subunits are fused to form the target echo signal, thereby reducing the impact of excessive saturation or weak signals during the detection of objects at varying distances and reflectivities.

The PDEs of two or more photosensitive subunits are different. The greater the differences in PDE among the photosensitive subunits, the more electron supply units are required, which improves measurement precision but also increases resource consumption. Therefore, the number of photosensitive subunits with different PDEs can be set according to the actual measurement precision requirement.

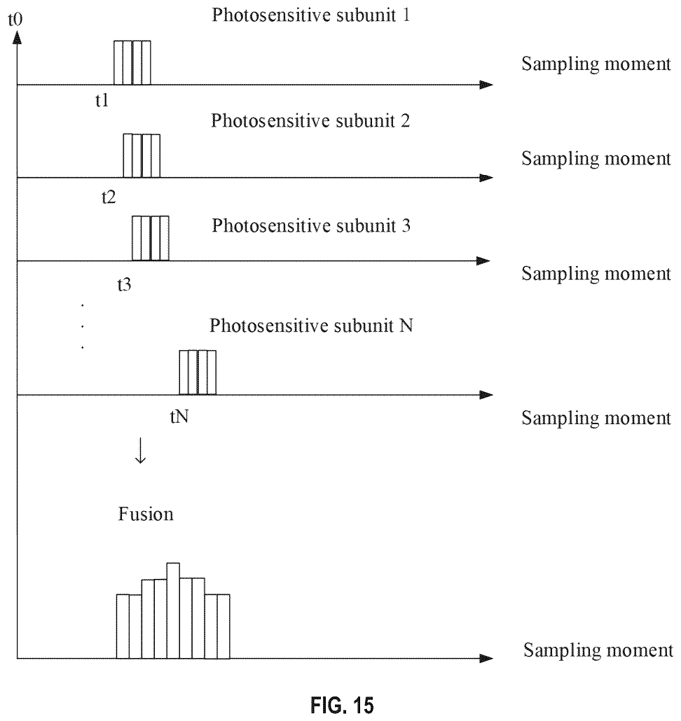

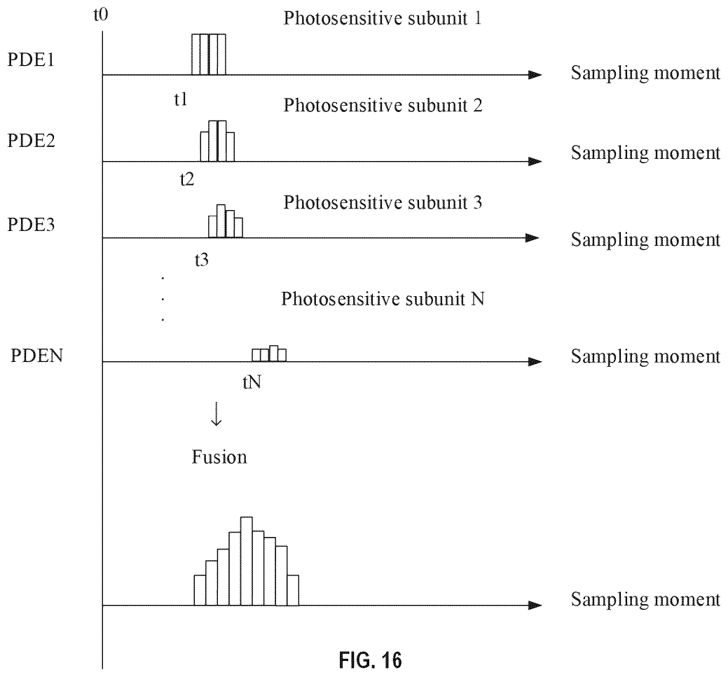

Referring to FIG. 15 and FIG. 16, FIG. 15 is a schematic diagram of echo signals reflected by a high-reflectivity object or a close object received by a receiving module with constant PDE, and FIG. 16 is a schematic diagram of echo signals reflected by a high-reflectivity object or a close object received by an echo signal receiving device provided by embodiments of the present application, in which PDE1>PDE2>PDE3>PDEN. As can be seen from FIG. 15, when a high-reflectivity object or a close object is detected, the level state signals of each photosensitive subunit are saturated, the waveform result after merging is over-saturated, and the sampling point number of the rising edge and the sampling point number of the falling edge are less. As can be seen from FIG. 16, in the echo signal receiving device with non-constant PDE, the sampling data of the photosensitive subunit with lower PDE is not saturated, and the sampling point number of the rising edge and the sampling point number of the falling edge of the echo signal after merging are greater. Thus, by setting the working voltage value and/or the working current value output by different electron supply units, the sampling point number of the rising edge and the sampling point number of the falling edge of the echo signal can be effectively increased, thereby expanding the dynamic range of the echo signal and further improving the measurement precision of the LiDAR system.

It should be noted that when a far distance object or a low-reflectivity object is detected, for the receiving module with constant PDE, the level state signals of each photosensitive subunit are too small, and the echo signal after merging is also too small, so that the measurement precision is poor. In the echo signal receiving device with non-constant PDE, the photosensitive subunit with higher PDE outputs a level state signal with higher amplitude, so that the echo signal after merging has a greater amplitude, thereby improving the measurement precision.

The echo signal receiving device provided by embodiments of the present application is introduced above, and the echo signal receiving method provided by embodiments of the present application is introduced below. It shall be understood that the echo signal receiving method provided by embodiments of the present application can be implemented based on the echo signal receiving device or based on the processing chip of the LiDAR system. The present application does not impose any specific limitation thereon. The echo signal receiving method provided by embodiments of the present application is described in detail below.

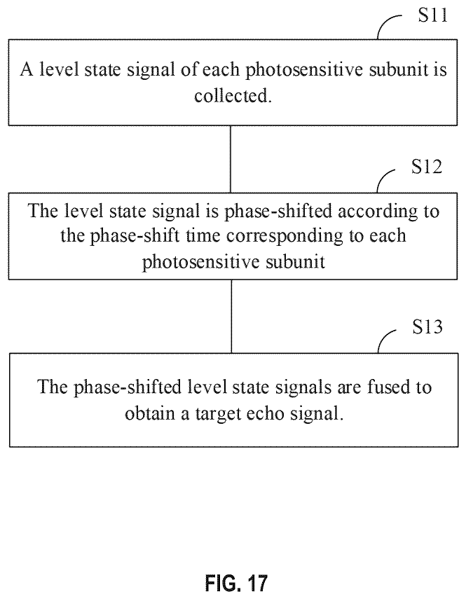

Please refer to FIG. 17, which shows an implementation process of an echo signal receiving method provided by embodiments of the present application. As shown in FIG. 17, the echo signal receiving method can include S11-S13.

In S11, a level state signal of each photosensitive subunit is collected.

In some embodiments, the receiving module of the LiDAR system can include a photosensitive receiving array, and the photosensitive receiving array including a plurality of photosensitive subunits. The echo light beam reflected by an object can form a corresponding level state signal after being received by the photosensitive subunits in the photosensitive receiving array, and the echo signal corresponding to the echo light beam can be obtained by collecting the level state signals of the photosensitive subunits.

In S12, the level state signal is phase-shifted according to the phase-shift time corresponding to each photosensitive subunit.

The phase-shift times corresponding to at least two photosensitive subunits are different.

In some embodiments, in order to improve the dynamic range of the echo signal in the time domain, the level state signal output by the photosensitive subunit can be phase-shifted, so that the sampling number of the echo signal is increased. The phase-shifting of the level state signal may be a phase-shifting mode in which a delay time is set on the sampling time, so that the photosensitive subunit outputs the level state signal after the delay time corresponding to the photosensitive subunit. The phase-shifting of the level state signal may also be a phase-shifting mode in which the level state signals output by a plurality of photosensitive subunits collected at the same sampling moment are input into a corresponding data shifter for sampling moment shifting.

In an embodiment of the present application, S12 can include the following steps:
a delay time of a sampling moment of the photosensitive subunit is determined according to the phase-shift time; and
after the delay time, the photosensitive subunit is triggered to output the level state signal.

In some embodiments, the delay time corresponding to each photosensitive subunit can be generated based on the delay architecture shown in FIG. 4 or FIG. 5, so that the flip-flop outputs the corresponding level state signal after the delay of each delay unit.

In some embodiments of the present application, S12 can also include the following steps:
the level state signal is input into a data shifter corresponding to the phase-shift time for sampling moment shifting.

In some embodiments, the shift distance of the data shifter corresponds to the phase-shift time, and the acquisition unit can input the level state signal output by each photosensitive subunit into the data shifter corresponding to the phase-shift time, so as to realize the phase shifting.

It can be understood that the level state signal output by only a portion of the photosensitive subunits may be phase-shifted, or the level state signal output by all of the photosensitive subunits may be phase-shifted, as long as the phase-shift times of at least two photosensitive subunits are different.

In S13, the phase-shifted level state signals are fused to obtain a target echo signal.

In some embodiments, fusing the phase-shifted level state signals can superimpose the level state signals at the same moment to obtain the target echo signal.

The LiDAR system can perform target recognition and distance calculation according to the target echo signal.

It should be noted that the process of target recognition and distance calculation based on the target echo signal may refer to existing recognition and calculation methods, and the present application does not repeat the description.

In some embodiments, the photosensitive receiving array has at least two photosensitive subunits with different photon detection efficiencies.

In some embodiments, the photosensitive receiving array can be powered by a power supply unit. The power supply unit can include a plurality of power supply subunits, each of which can correspond to a photosensitive subunit, and the power supply subunit corresponding to the photosensitive subunit provides working power for the photosensitive subunit. At least two power supply subunits output different power supply voltages and/or power supply currents, so that the photosensitive receiving array has at least two photosensitive subunits with different photon detection efficiencies.

As can be seen, the echo signal receiving method provided by embodiments of the present application shifts the level state signals output by the photosensitive subunits, and at least two unequal phase shift times are present, thereby improving the dynamic range of the sampling number. The target echo signal obtained by fusing the phase-shifted level state signals can have a larger dynamic range in the time domain, thereby improving the measurement accuracy of the LiDAR.

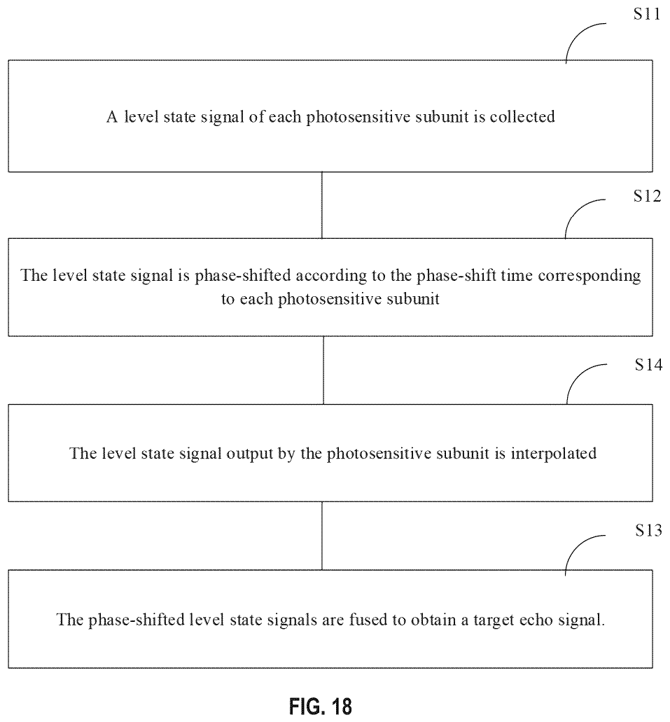

Referring to FIG. 18, which shows an implementation process of an echo signal receiving method provided by embodiments of the present application. As shown in FIG. 18, the echo signal receiving method can further include the following steps:
in S14, the level state signal output by the photosensitive subunit is interpolated.

In some embodiments, the interpolation multiple can be set according to the sampling accuracy requirement. The interpolation unit can use a linear interpolation method to perform interpolation, can use a spline interpolation method to perform interpolation, and can use a polynomial interpolation method to perform interpolation. The present application does not impose any specific limitation.

It should be noted that the interpolation methods used by different photosensitive subunits can be either the same or different, and the present application does not impose any specific limitation.

In some embodiments, the phase shift manner for phase shifting the sampling time can interpolate the phase-shifted level state signal, and the phase shift manner for phase shifting the data shifter can interpolate the level state signal before phase shifting or interpolate the level state after phase shifting.

The LiDAR system can interpolate the level state signals output by a portion of the photosensitive subunits according to the accuracy requirement, merge the phase-shifted interpolated level state signals, and obtain the target echo signal with more pulse width sampling numbers, rising edge sampling numbers, and falling edge sampling numbers, thereby further improving the dynamic range of the echo signal in the time domain and the measurement accuracy of the LiDAR system.

It should be understood that the sequence numbers of the steps in the above embodiments do not indicate the execution order. The execution order of each process should be determined based on its function and inherent logic, and should not be construed as limiting the implementation of the embodiments of the present application.

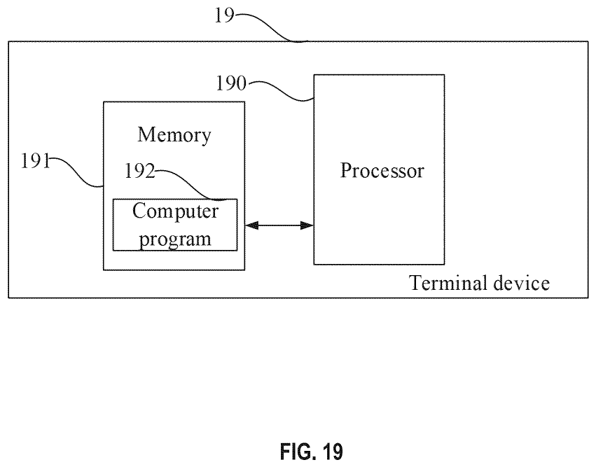

FIG. 19 is a schematic diagram of a structure of a terminal device according to some embodiments of the present application. As shown in FIG. 19, the terminal device 19 includes a processor 190, a memory 191, and a computer program 192, for example, an image segmentation program, stored in the memory 191 and executable in the processor 190. The processor 190 implements the steps in each of the echo signal receiving method embodiments, for example, S11-S13 shown in FIG. 17, when executing the computer program 192.

For example, the computer program 192 can be divided into an obtaining unit, a determining unit, and a calculating unit. The specific functions of the units can be referred to the related description in the corresponding embodiments of FIG. 3, and details are not described herein.

The terminal device may include, but is not limited to, the processor 190 and the memory 191. Those skilled in the art can understand that FIG. 19 is merely an example of the terminal device 19, and does not constitute a limitation on the terminal device 19. The terminal device 19 may include more or fewer components than those shown, may combine some components, or may include different components. For example, the terminal device may also include an input/output device, a network access device, a bus, and the like.

The processor 190 can be a central processing unit (CPU), and can also be other general-purpose processors, a digital signal processor (DSP), an application specific integrated circuit (ASIC), a field-programmable gate array (FPGA) or other programmable logic device, discrete gate or transistor logic device, discrete hardware component, or the like. The general-purpose processor can be a microprocessor, or the processor can also be any conventional processor, or the like.

The memory 191 can be an internal storage unit of the terminal device 19, for example, a hard disk or a memory of the terminal device 19. The memory 191 can also be an external storage device of the terminal device 19, for example, a plug-in hard disk, a smart media card (SMC), a secure digital (SD) card, a flash card, or the like, which is equipped on the terminal device 19. Further, the memory 191 can include both the internal storage unit and the external storage device of the terminal device 19. The memory 191 is used for storing the computer program and other programs and data required by the terminal device. The memory 191 can also be used for temporarily storing data that has been output or is to be output.

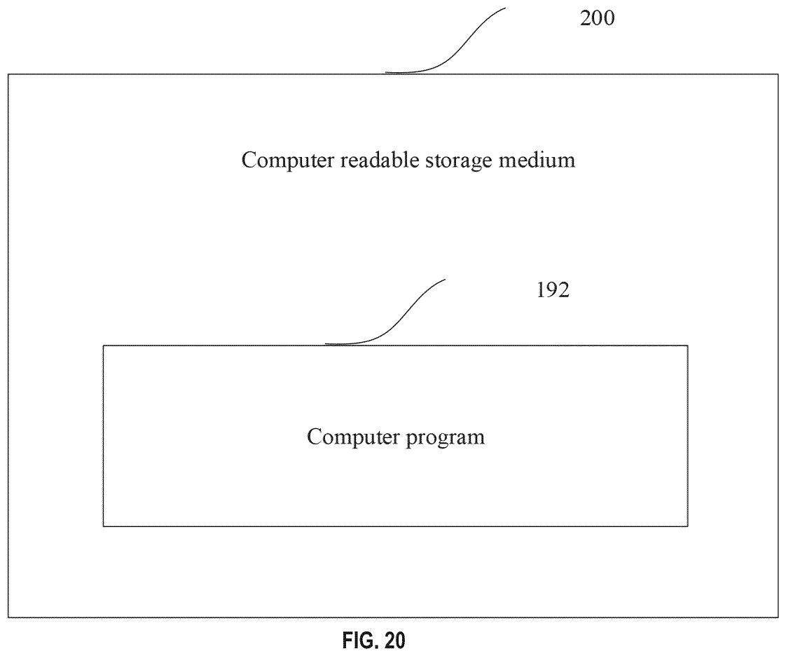

The embodiments of the present application further provide a computer readable storage medium. Referring to FIG. 20, which is a structural schematic diagram of a computer readable storage medium provided by embodiments of the present application. As shown in FIG. 20, the computer readable storage medium 200 stores a computer program 192. When the computer program 192 is executed by a processor, the echo signal receiving method can be implemented.

The embodiments of the present application further provide a computer program product. When the computer program product is run on a terminal device, the terminal device is enabled to implement the echo signal receiving method.

Those skilled in the art can clearly understand that, for the convenience and brevity of description, only the division of the above functional units and modules is exemplified. In actual application, the above functions can be completed by different functional units and modules based on actual needs. That is, the internal structure of the terminal device is divided into different functional units or modules to complete all or part of the functions described above. Each functional unit and module in the embodiments can be integrated into one processing unit, each unit can be physically present separately, or two or more units can be integrated into one unit. The integrated unit can be implemented in the form of hardware or in the form of a software functional unit. In addition, the specific names of the functional units and modules are only for the convenience of mutual distinction, and are not used to limit the protection scope of the present application. The specific working processes of the units and modules in the system can refer to the corresponding processes in the foregoing method embodiments, and will not be described herein.

In the above embodiments, the description of each embodiment has its own focus, and the parts not detailed or described in a certain embodiment can be referred to the related description of other embodiments.

Those of ordinary skill in the art can be aware that, in combination with the embodiments disclosed herein, units and algorithm steps of each example can be implemented by electronic hardware, or a combination of computer software and electronic hardware. Whether the functions are performed by hardware or software depends on particular applications and design constraints of the technical solutions. Professionals can use different methods to implement the described functions, but it should not be considered that such implementation goes beyond the scope of the present application.

The above embodiments are only used to illustrate the technical solutions of the present application, but not to limit them. Although the present application is described in detail with reference to the foregoing embodiments, those of ordinary skill in the art should understand that the technical solutions recorded in the foregoing embodiments can still be modified, or some technical features can be replaced by equivalents. The modifications or replacements do not make the essence of the corresponding technical solutions deviate from the spirit and scope of the technical solutions of the embodiments of the present application, and should be included in the protection scope of the present application.

What is claimed is:

1. An echo signal receiving method applied to a LiDAR system, wherein the LiDAR system comprises a photosensitive receiving array, and the photosensitive receiving array comprises a plurality of photosensitive subunits, the echo signal receiving method comprising:
collecting a level state signal of each photosensitive subunit;
phase-shifting the level state signal according to a phase shift time corresponding to each photosensitive subunit, wherein phase shift times corresponding to at least two photosensitive subunits are different; and
fusing the phase-shifted level state signal to obtain a target echo signal.

2. The echo signal receiving method according to claim 1, wherein the phase-shifting the level state signal according to the phase shift time corresponding to each photosensitive subunit comprises:
determining a delay time of a sampling moment of the photosensitive subunit according to the phase shift time; and
after the delay time, triggering the photosensitive subunit to output the level state signal.

3. The echo signal receiving method according to claim 1, wherein the phase-shifting the level state signal according to the phase shift time corresponding to each photosensitive subunit comprises:
inputting the level state signal into a data shifter corresponding to the phase shift time to shift a sampling moment.

4. The echo signal receiving method according to claim 3, further comprising, after the collecting the level state signal of each photosensitive subunit:
interpolating the level state signal output by the photosensitive subunit.

5. The echo signal receiving method according to claim 3, wherein the photosensitive receiving array comprises at least two photosensitive subunits with different photon detection efficiencies.

6. An echo signal receiving device, comprising:
a photosensitive receiving array comprising a plurality of photosensitive subunits;
an acquisition unit, connected with the photosensitive receiving array, for collecting a level state signal output by the photosensitive receiving array;
a phase-shifting unit, connected with an acquisition unit, for phase-shifting the level state signal according to a phase shift time corresponding to each photosensitive subunit, wherein the phase shift times corresponding to at least two photosensitive subunits are different; and
a fusion unit, connected with the phase-shifting unit, for fusing the phase-shifted level state signal to obtain a target echo signal.

7. The echo signal receiving device according to claim 6, wherein the phase-shifting unit comprises a clock generator and a delay unit, wherein:
the clock generator is configured to generate a sampling moment; and
the delay unit is configured to delay a collecting moment of an acquisition unit.

8. The echo signal receiving device according to claim 7, wherein the delay unit comprises a serial delay unit or a parallel delay unit.

9. The echo signal receiving device according to claim 6, wherein the phase shifting unit comprises a data shifter; and
the data shifter is configured to shift sampling moments of the level state signals.

10. The echo signal receiving device according to claim 6, further comprising:
an interpolation unit configured to interpolate the level state signals output by photo-sensing subunits.

11. The echo signal receiving device according to claim 10, further comprising:
a power supply unit comprising at least two power supply subunits with different power supply voltages or power supply currents, the power supply subunits being configured to supply power to corresponding photo-sensing subunits.

12. A terminal device, comprising a memory, a processor, and a computer program stored in the memory and executable on the processor, wherein the processor implements the echo signal receiving method according to claim 1 when executing readable instructions of the computer program.
